(19) United States
(12) Patent Application Publication
(10) Pub. No.: US 2016/0264748 A1
(43) Pub. Date: Sep. 15, 2016

(54) COMPOSITION FOR SPONGE RUBBER, SPONGE RUBBER MOLDED PRODUCT, AND METHOD FOR PRODUCING THE SAME

(71) Applicant: TOYODA GOSEI CO., LTD., Kiyosu-shi (JP)

(72) Inventors: Tomoaki OKITA, Kiyosu-shi (JP); Tatsushi GOTO, Kiyosu-shi (JP); Kenichi OKIHARA, Kiyosu-shi (JP); Atsushi KAMADA, Kiyosu-shi (JP)

(21) Appl. No.: 14/954,159

(22) Filed: Nov. 30, 2015

(30) Foreign Application Priority Data
Mar. 11, 2015 (JP) 2015-047827

(51) Int. Cl. C08J 9/08

(52) U.S. Cl. CPC C08J 9/08; C08J 2323/06; C08J 2203/02

(57) ABSTRACT

The present invention provides a composition for sponge rubber including 2 to 6 parts by mass of polyethylene, 0.5 to 12 parts by mass of baking soda as a foaming agent, and a sulfur vulcanizing agent with respect to 100 parts by mass of an ethylene-αolefin-nonconjugated diene copolymer.

### TECHNICAL FIELD

The present invention relates to a composition for sponge rubber and a sponge rubber molded product.

### BACKGROUND ART

Sponge rubber is widely used for, for example, sealing parts and end-connection parts of weather strips attached on automobile bodies, sealing materials on house door opening and closing parts, and universal buffer materials. As a rubber polymer of the sponge rubber, EPDM (ethylene-α-olefin-nonconjugated diene copolymer) has mostly been used because it is superior for aging resistance, ozone resistance, and the like.

A sponge rubber molded product can be produced by injecting a composition for sponge rubber into a mold for foam molding, or by extruding the composition for sponge rubber from a die for foam molding. In particular, various materials derived from the composition for sponge rubber, especially metal sulfides, are attached to the molding surface of the injecting-type mold, and repeating molding shots results in depositing such materials and thus fouling of the surface. The fouling of the surface of the mold causes problems of roughening of the surface of the sponge rubber molded product and difficulty in demolding. Accordingly, shot blasting, grinding, dummy rubber molding using cleaning rubber (see for example, Patent Document 1) or the like is performed to remove fouling of the mold every given number of shots (for example every 30 shots), which requires considerable man-hours and labor.

In addition, a vulcanization time for rubber molding tends to be shortened in recent years, and thus a mold temperature is set to be within a range of 190° C. to 220° C., which is higher than an usual temperature of about 180° C., in order to facilitate a vulcanization reaction. Under such a higher temperature, metal compounds become easier to adhere to the mold. This accelerates mold fouling.

As a literature in relation to the present invention, Patent Document 2 discloses a highly foamed EPDM sponge rubber composition, in which 5 parts to 50 parts by weight of baking soda (sodium bicarbonate) as a foaming agent and 1 part to 10 parts by weight of a lubricant are added with respect to 100 parts by weight of EPDM, in order to obtain an open-cell bubble structure to achieve an given open-cell content.

However, Patent Document 2 does not mention that baking soda is useful to prevent mold fouling. The inventors of the present invention have studied an EPDM sponge rubber composition of a mixture according to Patent Document 2, and found that foam growth will be defective at the time of foam molding (not publicly known).

Patent Document 3 describes a foam product obtained by mixing 70% by weight of an ethylene-propylene-dicyclopentadiene copolymer rubber and 30% by weight of linear low-density polyethylene; extruding the mixture to manufacture a thermoplastic elastomer composition; mixing 100 parts by weight of the thermoplastic elastomer composition and 3.0 parts by weight of a mixture containing 50 mol % of baking soda as a thermal decomposition type foaming agent and 50 mol % of citric acid as an auxiliary foaming agent; and extruding the mixture.

However, Patent Document 3 also does not mention that baking soda is useful to prevent mold fouling. Moreover, the inventors of the present invention have studied the thermoplastic elastomer composition contained of a mixture according to Patent Document 3, and found that problems such as defective surface texture and permanent compression set (i.e., “settling”) occur (not publicly known). This can be understood from the later-mentioned experimental results of Comparative Examples 2 to 4, and 7, in which large amounts of polyethylene are mixed.

### CITATION LIST

### Patent Documents

Patent Document 1: Japanese Patent Application Publication No. H6-345921 (JP 06-345921 A)

Patent Document 2: Japanese Patent Application Publication No. 2004-204000 (JP 2004-204000 A)

Patent Document 3: Japanese Patent Application Publication No. 2001-139740 (JP 2001-139740 A)

### SUMMARY OF INVENTION

### Technical Problem

It is an object of the present invention to solve problems of the above-mentioned mold fouling, defective surface texture, defective foam growth, and permanent compression set (settling), and to provide a composition for sponge rubber and a sponge rubber molded product that can prevent mold fouling by selecting an optimal mixing amount of PE and baking soda, so that the number of man-hours for cleaning the mold can be decreased, and that can satisfy a variety of characteristics such as surface texture, foam growth, and permanent compression set (settling).

### Solution to Problem

The above-described mold fouling is considered to be generated according to the following mechanism.

H₂S gas is generated in a main reaction to vulcanize an EPDM polymer with a sulfur vulcanizing agent.

Generally, a vulcanization accelerator derived from thiuram, dithiocarbamate, or thiazole is added in order to facilitate the main reaction, so that a vulcanization time will be shortened; however, an excess amount of the vulcanization accelerator blooms, CS₂ is decomposed from the vulcanization accelerator, or a metal ion such as a zinc ion is released from a dithiocarbamate vulcanization accelerator.

Inorganic zinc oxide or stearic acid that is an organic fatty acid is generally added as a vulcanization auxiliary agent that facilitates the action of a sulfur vulcanizing agent; however, a side reaction occurs between the zinc oxide and stearic acid, and thus zinc stearate is generated as an intermediate product.

The released metal ion such as a zinc ion, added zinc oxide, and zinc stearate generated as an intermediate product react with the H₂S gas, the sulfur vulcanizing agent, or sulfur derived from the vulcanization accelerator to generate metal sulfides such as zinc sulfide (ZnS), and the metal sulfides are considered to be precipitated on the molding surface of the mold.

According to this speculation, means A, B, and C below are adopted into the present invention in order to solve the problems described above. Note that when a mixing amount of a material other than an ethylene-αolefin-nonconjugated diene copolymer is mentioned herein, the amount is described in part (s) by mass with respect to 100 parts by mass of an unvulcanized ethylene-αolefin-nonconjugated diene copolymer.

A. Composition for Sponge Rubber

The composition for sponge rubber of the present invention includes 2 to 6 parts by mass of polyethylene, 0.5 to 12 parts by mass of baking soda as a foaming agent, and a sulfur vulcanizing agent with respect to 100 parts by mass of an ethylene-αolefin-nonconjugated diene copolymer.

The mechanisms described below is considered to contribute to effects on actions of the present invention.

The baking soda (sodium bicarbonate) mixed as a foaming agent is decomposed at the time of foaming and molding, and releases CO₂ gas and sodium ions. As described above, mold fouling is considered to be derived from metal sulfides precipitated on the mold. Sodium ions thus released from the baking soda neutralizes acids generated from the sulfur vulcanizing agent and the vulcanization accelerator, so that binding between metal sulfides such as zinc sulfide and the mold made of metal will be prevented. Accordingly, mold fouling can be prevented or reduced. To substantially achieve this action, a mixing amount of the baking soda should be 0.5 parts by mass or more, preferably 1.0 part by mass or more, and more preferably 2.0 parts by mass or more.

Meanwhile, if the mixing amount of baking soda is excessive, defects such as crater, depression, and flow blemish occur on the surface of sponge rubber, which results in defective surface texture. To prevent such defective surface texture, a mixing amount of baking soda should be 12 parts by mass or less, preferably 11.5 parts by mass or less.

The mixed polyethylene is compatible with the ethylene-αolefin-nonconjugated diene copolymer, and has a foam growth property that is necessary for sponge rubber molded products as well as fluidity at a high temperature and a sufficient release property from a mold. To substantially achieve this action, a mixing amount of polyethylene should be 2 parts by mass or more.

Meanwhile, if the mixing amount of polyethylene is excessive, permanent compression set will be worsened, which results in defective settling. Thus, the mixing amount of polyethylene should be 6 parts by mass or less in order to prevent defective surface texture.

As mentioned above, the present invention provides a composition for sponge rubber and a sponge rubber molded product that can prevent mold fouling by selecting optimal mixing amounts of polyethylene and baking soda, so that the number of man-hours for cleaning the mold can be decreased, and that can satisfy a variety of characteristics such as surface texture, foam growth, and permanent compression set (settling).

Details of components, aspects, and the like of the present invention will be explained below.

1. Ethylene-αOlefin-Nonconjugated Diene Copolymer (Hereinafter, Referred to as “EPDM”) Polymer

αolefin is not particularly limited, and examples thereof include propylene, 1-butene, 1-pentene, 1-hexene, 4-methyl-1-pentene, 1-octene, and 1-decene. Among them, propylene is preferred.

Nonconjugated diene is not particularly limited, and examples thereof include 1,4-hexadiene, dicyclopentadiene, and 5-ethylidene-2-norbornene.

2. Polyethylene (Hereinafter, Referred to as “PE”)

Types of PE are not particularly limited, and can be selected depending on purposes of uses. When used in weather strips, high-pressure low-density polyethylene (LDPE), linear low-density polyethylene (LLDPE), or a mixture thereof is preferably used. They are highly flexible, highly flowable at a higher temperature, and also have excellent physical strength such as tear strength and tensile strength.

3. Sulfur Vulcanizing Agent

A sulfur vulcanizing agent is not particularly limited, and examples thereof include sulfur, sulfur compounds, maleimides, and organic sulfur-containing vulcanizing agents. One of them may be used alone, or two or more of them may be used in combination.

4. Vulcanization Accelerator

A vulcanization accelerator can suitably be mixed in order to promote vulcanization. Example of the vulcanization accelerator will be listed below, and one or two or more of them can be used. The present invention is preferred when a vulcanization accelerator of a metal salt such as dithiocarbamate and phosphorodithioate is mixed, because the present invention can prevent mold fouling caused by precipitation of vulcanization accelerator-derived metal sulfides.

(1) Thiurams

Examples of thiurams include tetramethylthiuram disulfide (TMTD), tetraethylthiuram disulfide (TETD), tetrabutylthiuram disulfide (TBTD), tetrakis(2-ethylhexyl)thiuram disulfide, tetramethylthiuram monosulfide (TMTM), and dipentamethylenethiuram tetrasulfide (DPTT).

(2) Dithiocarbamates

Examples of dithiocarbamates include zinc dimethyldithiocarbamate (ZnMDC), zinc diethyldithiocarbamate (ZnEDC), zinc dibutyldithiocarbamate (ZnBDC), zinc N-ethyl-N-phenyldithiocarbamate (ZnEPDC), zinc N-pentamethylenedithiocarbamate (ZnPDC), zinc dibenzyldithiocarbamate (ZBEC), sodium dimethyldithiocarbamate (NaMDC), sodium diethyldithiocarbamate (NaEDC), sodium dibutyldithiocarbamate (NaBDC), copper dimethyldithiocarbamate (CuMDC), ferric dimethyldithiocarbamate (FeMDC), tellurium diethyldithiocarbamate (TeEDC), piperidine pentamethylenedithiocarbamate (PPDC), and pipecolin pipecolyldithiocarbamate.

(3) Thiazoles

Examples of thiazoles include 2-mercaptobenzothiazole (MBT), dibenzothiazyl disulfide (MBTS), a zinc salt of 2-mercaptobenzothiazole (ZnMBT), a cyclohexylamine salt of 2-mercaptobenzothiazole (CMBT), 2-(N,N′-diethyldithiocarbamoylthio)benzothiazole, and 2-(4′-morpholinodithio)benzothiazole (MDB).

(4) Sulfenamides

Examples of sulfenamides include N-cyclohexyl-2-benzothiazolylsulfenamide (CBS), N-t-butyl-2-benzothiazolylsulfenamide (BBS), N-oxydiethylene-2-benzothiazolylsulfenamide (OBS), and N,N′-dicyclohexyl-2-benzothiazolylsulfenamide.

(5) Phosphorodithioates

Zinc dialkylphosphorodithioates.

5. Plasticizer

A plasticizer can suitably be mixed in order to give plasticity to a composition, and to facilitate processing. Examples of the plasticizer include petroleum plasticizers, such as process oils (such as a paraffin process oil, a naphthene process oil, and an aromatic process oil), lubricating oils, petroleum asphalt, and petrolatum; coal tar softeners such as coal tar and coal-tar pitch; fatty oil plasticizers, such as castor oil, flaxseed oil, canola oil, and coconut oil; waxes, such as beeswax, carnauba wax, and lanolin; fatty acids and fatty acid salts, such as ricinoleic acid, palmitic acid, stearic acid barium, calcium stearate, and zinc laurate; synthetic macromolecular materials, such as petroleum resins, atactic polypropylene, and coumarone indene resins; tall oil; and sub (factice), but are not limited thereto. When a process oil is mixed, a mixing amount thereof is preferably 12 parts by mass or more in order to facilitate processing, and is preferably 60 parts by mass or less in order to prevent blooming.

6. Foaming Agent

A foaming agent must contain 0.5 to 12 parts by mass of baking soda, and other foaming agents can suitably be mixed for a concomitant use.

Examples of other foaming agents include 4,4′-oxybis(benzenesulfonyl hydrazide) (OBSH), azodicarbonamide (ADCA), N,N′-dinitrosopentamethylenetetramine (DPT), p-toluenesulfonyl hydrazide (TSH), and 2,2′-azobisisobutyronitrile (AIBN).

7. Other Mixing Materials

In addition to the mixing materials described above, fillers, processing aids, crosslinking auxiliary agents, foaming auxiliary agents, antioxidants, acid acceptors, antiscorching agents, and/or colorants can suitably be mixed.

Examples of the fillers may include carbon black, calcium carbonate, talc, silica, and calcined clay.

Examples of the processing aids include fatty acids such as stearic acid.

Examples of the crosslinking auxiliary agents include polyethylene glycol (PEG), zinc oxide (ZnO, flowers of zinc), fatty acid salts such as zinc stearate, and magnesium oxide. The present invention is preferred, in particular, when a crosslinking auxiliary agent of a metal compound such as zinc oxide and zinc stearate is mixed, because the present invention can prevent mold fouling caused by precipitation of crosslinking auxiliary agent-derived metal sulfides.

Examples of the foaming auxiliary agents include urea and sodium benzenesulfinate.

B. Sponge Rubber Molded Product

The sponge rubber molded product of the present invention is produced by foam molding from the composition for sponge rubber including 2 to 6 parts by mass of polyethylene, 0.5 to 12 parts by mass of baking soda as a foaming agent, and a sulfur vulcanizing agent with respect to 100 parts by mass of an ethylene-αolefin-nonconjugated diene copolymer.

Examples of uses of the sponge rubber molded product include sealing parts and end-connection parts of weather strips of automobile bodies, sealing materials on house door opening and closing parts, and universal buffer materials, but are not limited thereto. Sealing parts and end-connection parts of weather strips may or may not include inserts made of resin or inserts made of metal.

C. Method for Producing Sponge Rubber Molded Product

In the method for producing the sponge rubber molded product of the present invention, the sponge rubber molded product is produced by foam molding from the composition for sponge rubber including 2 to 6 parts by mass of polyethylene, 0.5 to 12 parts by mass of baking soda as a foaming agent, and a sulfur vulcanizing agent with respect to 100 parts by mass of an ethylene-αolefin-nonconjugated diene copolymer, in a mold at a temperature of 190 to 220° C. As mentioned above, setting a mold temperature to within a range of 190 to 220° C. to make a vulcanization time shorter usually accelerates mold fouling. In the present invention, the above mechanism allows preventing mold fouling even in such a case, and thus, the present invention is preferred.

### Advantageous Effects of Invention

The present invention provides a composition for sponge rubber and a sponge rubber molded product that can prevent mold fouling, so that the number of man-hours for cleaning the mold can be decreased, and that can satisfy a variety of characteristics such as surface texture, foam growth, and permanent compression set (settling).

### BRIEF DESCRIPTION OF DRAWINGS

FIG. 1A is a schematic view of a weather strip that is attached to a door of an automobile, FIG. 1B is a geometry view of a sponge rubber molded product that is produced by foam molding from each of compositions for sponge rubbers of Examples and Comparative Examples, and FIG. 1C is a view illustrating a method for testing permanent compression set of the sponge rubber molded product; and

FIG. 2 is a scatter diagram in which data obtained in Examples and Comparative Examples is plotted, mixing amounts of PE are shown in the horizontal axis, and mixing amounts of baking soda are shown in the vertical axis.

### DESCRIPTION OF EMBODIMENTS

A sponge rubber molded product is produced by foam molding from a composition for sponge rubber including 2 to 6 parts by mass of PE, 0.5 to 12 parts by mass of baking soda as a foaming agent, and a sulfur vulcanizing agent with respect to 100 parts by mass of an EPDM polymer, in a mold at a temperature of 190 to 220° C.

### EXAMPLES

A composition for sponge rubber was produced for each of Examples 1 to 8 according to the mixing compositions shown in Table 1, and a composition for sponge rubber was produced for each of Comparative Examples 1 to 8 according to the mixing compositions shown in Table 2.

TABLE 1

| | Mixing Kind | | Example 1 | Example 2 | Example 3 | Example 4 |
|---|---|---|---|---|---|---|
| | | Mixing | | | | |
| | | Material | | | | |
| Mixing | Polymer | EPDM polymer | 100 | 100 | 100 | 100 |
| Composition | | PE | 3.0 | 4.0 | 6.0 | 3.0 |
| (part(s) | Filler | Carbon Black | 50 | 50 | 50 | 50 |
| by mass) | Plasticizer | Process Oil | 46 | 46 | 46 | 46 |
| | Processing Aid | Fatty Acid | 2 | 2 | 2 | 2 |
| | Crosslinking | PEG | 1 | 1 | 1 | 1 |
| | Auxiliary Agent | Zinc Fatty | 3 | 3 | 3 | 3 |
| | | Acid | | | | |
| | Vulcanizing Agent | Sulfur | 0.6 | 0.6 | 0.6 | 0.6 |
| | Vulcanization | ZBEC | 0.5 | 0.5 | 0.5 | 0.5 |
| | Accelerator | MBT | 0.5 | 0.5 | 0.5 | 0.5 |
| | | TMTD | 2 | 2 | 2 | 2 |
| | | ZAT | 1 | 1 | 1 | 1 |
| | Foaming Auxiliary | Urea | 1 | 1 | 1 | 1 |
| | Agent | | | | | |
| | Foaming Agent | ADCA | 8 | 8 | 8 | 8 |
| | | Baking Soda | 1.0 | 5.0 | 10.0 | 6.5 |
| | | Target Value | | | | |
| Evaluation | Surface Texture | No Craters | Good | Good | Good | Good |
| Item | | etc. | | | | |
| | Foam Growth (mm) | 120 or above | 128 | 132 | 130 | 140 |
| | Hot Strength | 500 or above | 770 | 674 | 725 | 619 |
| | (Kpa) | | | | | |
| | Settling (%) | 52 or below | 42 | 48 | 50 | 49.5 |
| | Modulus of | 200 or above | 220 | 211 | 205 | 206 |
| | Rigidity (Kpa) | | | | | |
| | Number of Shots | 60 shots or | 100 | 200 or | 200 or | 200 or |
| | for Cleaning Fouled | more | | more | more | more |
| | Mold | | | | | |
| | Mixing Kind | | Example 5 | Example 6 | Example 7 | Example 8 |
| | | Mixing | | | | |
| | | Material | | | | |
| Mixing | Polymer | EPDM polymer | 100 | 100 | 100 | 100 |
| Composition | | PE | 40 | 50 | 6.0 | 2.0 |
| (part(s) | Filler | Carbon Black | 50 | 50 | 50 | 50 |
| by mass) | Plasticizer | Process Oil | 46 | 46 | 46 | 46 |
| | Processing Aid | Fatty Acid | 2 | 2 | 2 | 2 |
| | Crosslinking | PEG | 1 | 1 | 1 | 1 |
| | Auxiliary Agent | Zinc Fatty | 3 | 3 | 3 | 3 |
| | | Acid | | | | |
| | Vulcanizing Agent | Sulfur | 0.6 | 0.6 | 0.6 | 0.6 |
| | Vulcanization | ZBEC | 0.5 | 0.5 | 0.5 | 0.5 |
| | Accelerator | MBT | 0.5 | 0.5 | 0.5 | 0.5 |
| | | TMTD | 2 | 2 | 2 | 2 |
| | | ZAT | 1 | 1 | 1 | 1 |
| | Foaming Auxiliary | Urea | 1 | 1 | 1 | 1 |
| | Agent | | | | | |
| | Foaming Agent | ADCA | 8 | 8 | 8 | 8 |
| | | Baking Soda | 8.0 | 10.0 | 11.5 | 0.5 |
| | | Target Value | | | | |
| Evaluation | Surface Texture | No Craters | Good | Good | Good | Good |
| Item | | etc. | | | | |
| | Foam Growth (mm) | 120 or above | 137 | 140 | 142 | 120 |
| | Hot Strength | 500 or above | 620 | 609 | 508 | 720 |
| | (Kpa) | | | | | |
| | Settling (%) | 52 or below | 31.4 | 35.5 | 39 | 45 |
| | Modulus of | 200 or above | 219 | 238 | 243 | 210 |
| | Rigidity (Kpa) | | | | | |
| | Number of Shots | 60 shots or | 200 or | 200 or | 200 or | 60 |
| | for Cleaning Fouled | more | more | more | more | |
| | Mold | | | | | |

TABLE 2

| | | | Comparative | Comparative | Comparative | Comparative |
|---|---|---|---|---|---|---|
| | Mixing Kind | | Example 1 | Example 2 | Example 3 | Example 4 |
| | | Mixing | | | | |
| | | Material | | | | |
| Mixing | Polymer | EPDM | 100 | 100 | 100 | 100 |
| Composition | | polymer | | | | |
| (part(s) | | PE | 6.0 | 8.0 | 10.0 | 10.0 |
| by mass) | Filler | Carbon | 50 | 50 | 50 | 50 |
| | | Black | | | | |
| | Plasticizer | Process Oil | 46 | 46 | 46 | 46 |
| | Processing Aid | Fatty Acid | 2 | 2 | 2 | 2 |
| | Crosslinking | PEG | 1 | 1 | 1 | 1 |
| | Auxiliary Agent | Zinc Fatty | 3 | 3 | 3 | 3 |
| | | Acid | | | | |
| | Vulcanizing | Sulfur | 0.6 | 0.6 | 0.6 | 0.6 |
| | Agent | | | | | |
| | Vulcanization | ZBEC | 0.5 | 0.5 | 0.5 | 0.5 |
| | Accelerator | MBT | 0.5 | 0.5 | 0.5 | 0.5 |
| | | TMTD | 2 | 2 | 2 | 2 |
| | | ZAT | 1 | 1 | 1 | 1 |
| | Foaming | Urea | 1 | 1 | 1 | 1 |
| | Auxiliary Agent | | | | | |
| | Foaming Agent | ADCA | 8 | 8 | 8 | 8 |
| | | Baking Soda | 15.0 | 18.0 | 26.0 | 28.0 |
| | | OBSH | — | — | — | — |
| | | Target | | | | |
| | | Value | | | | |
| Evaluation | Surface Texture | No Craters | Poor | Poor | Poor | Poor |
| Item | | etc. | | | | |
| | Foam Growth (mm) | 120 or above | 145 | 148 | 152 | 160 |
| | Hot Strength | 500 or above | 560 | 520 | 524 | 486 |
| | (Kpa) | | | | | Poor |
| | Settling (%) | 52 or below | 45 | 54 | 56 | 60 |
| | | | | Poor | Poor | Poor |
| | Modulus of | 200 or above | 178 | 162 | 156 | 150 |
| | Rigidity (Kpa) | | Poor | Poor | Poor | Poor |
| | Number of Shots | 60 shots or | 200 or | 200 or | 200 or | 200 or |
| | for Cleaning | more | more | more | more | more |
| | Fouled Mold | | | | | |
| | | | Comparative | Comparative | Comparative | Comparative |
| | Mixing Kind | | Example 5 | Example 6 | Example 7 | Example 8 |
| | | Mixing | | | | |
| | | Material | | | | |
| Mixing | Polymer | EPDM | 100 | 100 | 100 | 100 |
| Composition | | polymer | | | | |
| (part(s) | | PE | 2.5 | 4.5 | 7.0 | 5.0 |
| by mass) | Filler | Carbon | 50 | 50 | 50 | 50 |
| | | Black | | | | |
| | Plasticizer | Process Oil | 46 | 46 | 46 | 46 |
| | Processing Aid | Fatty Acid | 2 | 2 | 2 | 2 |
| | Crosslinking | PEG | 1 | 1 | 1 | 1 |
| | Auxiliary Agent | Zinc Fatty | 3 | 3 | 3 | 3 |
| | | Acid | | | | |
| | Vulcanizing | Sulfur | 0.6 | 0.6 | 0.6 | 0.6 |
| | Agent | | | | | |
| | Vulcanization | ZBEC | 0.5 | 0.5 | 0.5 | 0.5 |
| | Accelerator | MBT | 0.5 | 0.5 | 0.5 | 0.5 |
| | | TMTD | 2 | 2 | 2 | 2 |
| | | ZAT | 1 | 1 | 1 | 1 |
| | Foaming | Urea | 1 | 1 | 1 | 1 |
| | Auxiliary Agent | | | | | |
| | Foaming Agent | ADCA | 8 | 8 | 8 | 8 |
| | | Baking Soda | 14.0 | 15.0 | 14.0 | — |
| | | OBSH | — | — | — | 2.0 |
| | | Target | | | | |
| | | Value | | | | |
| Evaluation | Surface Texture | No Craters | Poor | Poor | Poor | Good |
| Item | | etc. | | | | |
| | Foam Growth | 120 or above | 138 | 158 | 151 | 139 |
| | (mm) | | | | | |
| | Hot Strength | 500 or above | 520 | 473 | 449 | 680 |
| | (Kpa) | | | Poor | Poor | |
| | Settling (%) | 52 or below | 55 | 58 | 62 | 48 |
| | | | Poor | Poor | Poor | |
| | Modulus of | 200 or above | 180 | 220 | 253 | 223 |
| | Rigidity (Kpa) | | Poor | | | |
| | Number of Shots | 60 shots or | 200 or | 200 or | 200 or | 30 |
| | for Cleaning | more | more | more | more | Poor |
| | Fouled Mold | | | | | |

Polyethylene (PE) used was a mixture of LD and LLD. The carbon black as a filler was the MAF grade (Medium Abrasion Furnace). The process oil as a plasticizer was paraffin process oil. The fatty acid as a processing aid was stearic acid. The zinc fatty acid as a crosslinking auxiliary agent was zinc stearate. Among the vulcanization accelerators, “ZAT” refers to a zinc dialkylphosphorodithioate (the product name of Rhein Chemie Rheinau GmbH is “Rhenogran ZAT-70”).

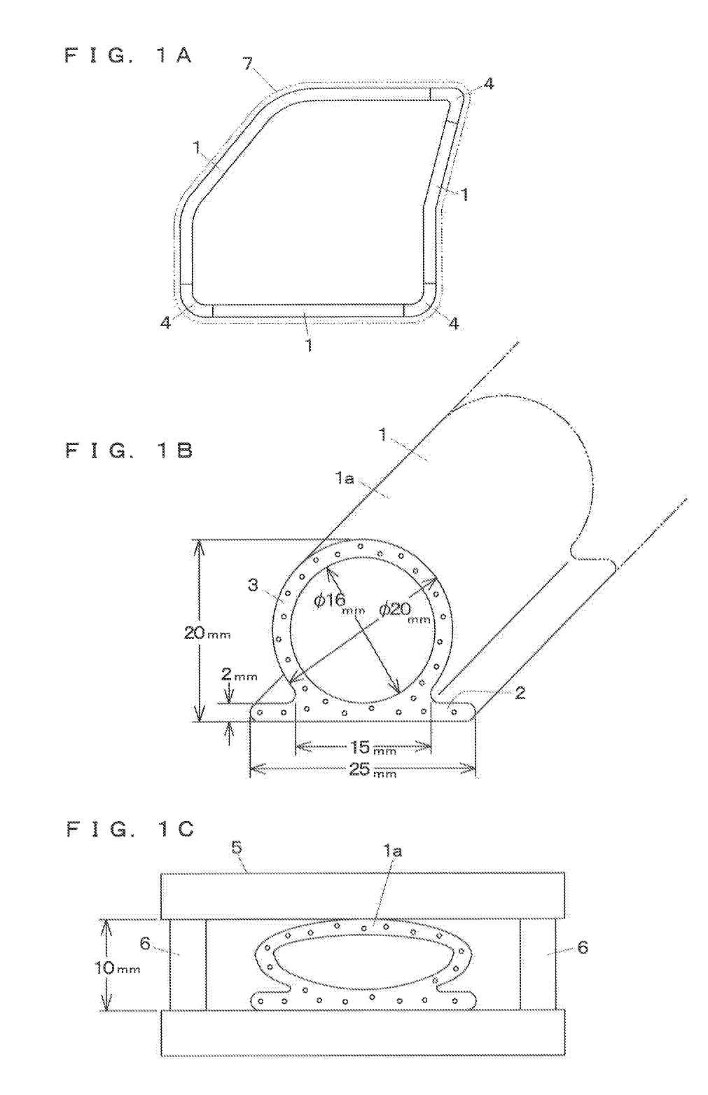

By using each of the compositions for sponge rubber, for example, the sealing part (the sealing part 3 described below) of the weather strip 1 shown in FIG. 1A and the end-connection part 4, which are attached to a door of an automobile 7, can be produced by foam molding as sponge rubber molded products. Each of the sealing part 3 and the end-connection part 4 of the weather strip 1 may or may not include an insert made of resin or an insert made of metal.

On an experimental basis, each of the compositions for sponge rubber was kneaded in a kneading machine, and then was injected into a cavity of a mold (not illustrated) at a temperature of 19000, at an injection velocity of 3 mm/second. The sponge rubber molded product 1 having a plate-like base 2 and the hollow sealing part 3, which are shown in FIG. 1B, was produced by foam molding (molding time was 180 seconds), so that the sponge rubber molded product 1 has a cross sectional shape that is identical to the general part of the actual weather strip 1 (the foaming structure and skin layer were also identical), and then the vulcanized sponge rubber molded product 1 was demolded from a mold. Among the following items to evaluate each of the sponge rubber molded product 1, “1. Surface texture,” “2. Foam growth,” “4. Permanent compression set (settling),” and “6. Mold fouling” were observed and measured. Evaluation results are shown in Tables 1 and 2 above.

For evaluation of the items “3 Hot strength,” and “5 Rigidity,” test pieces each having a dimension and a shape conforming to each standard were molded by using the respective compositions for sponge rubber with the same procedure and the same condition as described above. Evaluation results are shown in Tables 1 and 2 above.

1. Surface Texture

The surface texture of each of the demolded sponge rubber molded products 1 was visually observed. If the product does not have any crater, depression, and/or flow blemish, it was evaluated as “good”, and if the product has any of them, it was evaluated as “poor”.

2. Foam Growth

Foaming distances in the cavity of the mold were measured. The target value was set as 120 mm or above.

3. Hot Strength

Tensile tests were conducted at 150° C. according to JIS K6251 in order to measure hot tensile strength. The target value was set as 500 kPa or above.

4. Permanent Compression Set (Settling)

(1) The sponge rubber molded product 1 shown in FIG. 1B was cut to obtain a test piece 1a having a length of 60 mm.

(2) First, heights of three portions of the test piece 1a were measured (heights before the test) by using vernier calipers or a pachymeter (mass of the weight was 1 g).

(3) Next, spacers 6 each having a height that was 50% of the height measured at the middle of the length of the test piece, and the test piece 1a were set on a compression device 5 of a test device according to Item 5 in JIS K6262 or ISO815-1 as shown in FIG. 1C. The test piece 1a was compressed in the height direction.

(4) The compression device 5 holding the compressed test piece 1a was placed in an air-oven aging test instrument (not illustrated) at a temperature within a range of 70±2° C., and was heated for 22^{0 to +2} hours.

After the heating was completed, the compression device 5 was taken out from the air-oven aging test instrument, and the test piece 1a was quickly taken out from the compression device 5. Subsequently, the test piece 1a was left on a wooden stand at a room temperature for 30 minutes (according to Item 5 in JIS K6262 or Item 7.5 in ISO815-1).

(5) After the test piece 1a was left for 30 minutes, heights of the three portions of the test piece 1a, which were same portions as those measured before the test, were measured (heights after the test) by using vernier calipers or a pachymeter (mass of the weight was 1 g).

(6) For each of the three portions of the test piece 1a, CS was calculated according to the equation below, and the average value was identified as the permanent compression set. The target value was set as 52% or below.

CS=(t₀−t₁)/(t₀−t₂)×100

CS: Permanent compression set (%)

t₀: Height before the test (mm)

t₁: Height after the test (mm)

t₂: Height of the spacer (mm)

5. Modulus of Rigidity

Low-elongation tensile tests were conducted at 23° C. according to JIS K6254 in order to measure static shear modulus of elasticity (modulus of rigidity). The target value was set as 200 kPa or above.

6. Mold Fouling

The molding was repeated in order to determine how many shots were performed until the cavity surface of the mold was fouled and needed to be cleaned. The target value was set as 60 shots or more.

<Result of Evaluation Items>

In Comparative Example 8, in which baking soda was not mixed, the number of shots for mold fouling was 30, that is, half the target value.

In each of Examples 1 to 8, in which 0.5 to 11.5 parts by mass of baking soda was mixed, the number of shots for mold fouling was at least twice as many as that in Comparative Example 8 (especially, in each of Examples 1 to 7, it was at least 3.3 times, and in each of Examples 2 to 7, it was at least 6.6 times as many as that in Comparative Example 8), and thus the number of man-hours for cleaning the mold can be decreased. The surface texture obtained in each of Examples 1 to 8 was evaluated as “good”.

In each of Comparative Examples 1 to 7, in which a large amount of baking soda was mixed, the number of shots for mold fouling was at least 6.6 times as many as that in Comparative Example 8; however, the surface texture obtained in each of Comparative Examples 1 to 7 was evaluated as “poor”, and modulus of rigidity obtained in each of Comparative Examples 1 to 5 was also lowered.

In each of Examples 1 to 8, in which 2 to 6 parts by mass of PE was mixed, foam growth was the target value of 120 mm or above. Permanent compression set (settling) was the target value of 52% or below.

However, in Example 8, in which 2 parts by mass of PE was mixed, foam growth was 120 mm that is the lower limit of the target value, and thus when the mixing amount of PE is less than 2 parts by mass, foam growth is not considered to attain the target value.

In each of Comparative Examples 2 to 4, and 7, in which more than 6 parts by mass of PE were mixed, although foam growth was the target value of 120 mm or above, permanent compression set (settling) was worsened, and modulus of rigidity was also lowered particularly in each of Comparative Examples 2 to 4. Permanent compression set (settling) was worsened in Comparative Examples 1, 5, 6 in which a large amount of baking soda was mixed although a mixing amount of PE was 2 to 6 parts by mass.

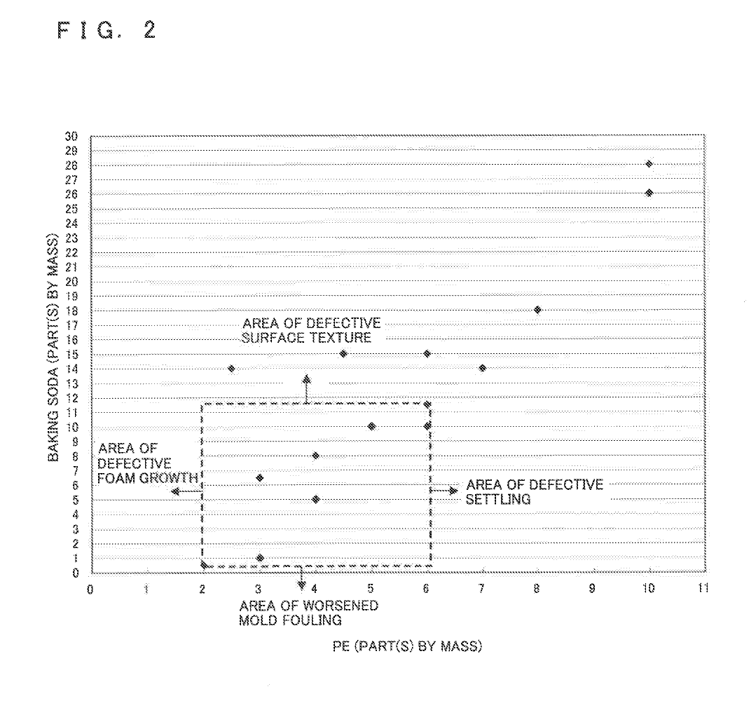

FIG. 2 is a scatter diagram in which data obtained in Examples 1 to 8 and Comparative Examples 1 to 8 is plotted according to the above results. Mixing amounts of PE are shown in the horizontal axis, and mixing amounts of baking soda are shown in the vertical axis. An area surrounded by a broken-line frame contains results of Examples 1 to 8, and it is the area of the present invention. The area below the broken-line frame is the area of worsened mold fouling, the area above the frame is the area of defective surface texture, the area on the left side of the frame is the area of defective foam growth, and the area on the right side of the frame is the area of defective settling.

Note that the present invention is not limited to the above examples, and can be embodied by making appropriate modification(s) without departing from the spirit of the present invention.

### REFERENCE SIGNS LIST

1. Sponge rubber molded product
1a. Test piece
2. Base
3. Sealing part
4. End-connection part
5. Compression device
6. Spacer
7. Door

1. A composition for sponge rubber comprising 2 to 6 parts by mass of polyethylene, 0.5 to 12 parts by mass of baking soda as a foaming agent, and a sulfur vulcanizing agent with respect to 100 parts by mass of an ethylene-αolefin-nonconjugated diene copolymer.

2. The composition for sponge rubber according to claim 1, wherein the polyethylene is high-pressure low-density polyethylene, linear low-density polyethylene, or a mixture thereof.

3. The composition for sponge rubber according to claim 1, further comprising 12 parts by mass or more of a process oil as a plasticizer with respect to 100 parts by mass of the ethylene-αolefin-nonconjugated diene copolymer.

4. A sponge rubber molded product that is produced by foam molding from the composition for sponge rubber as claimed in claim 1.

5. The sponge rubber molded product according to claim 4, wherein the sponge rubber molded product is a sealing part or an end-connection part of a weather strip.

6. The sponge rubber molded product according to claim 5, wherein the sealing part or the end-connection part include an insert made of resin or an insert made of metal.

7. A method for producing a sponge rubber molded product, the method comprising foam molding the composition for sponge rubber as claimed in claim 1 in a mold at a temperature of 190° C. to 220° C.
